(19) United States
(12) Patent Application Publication
(10) Pub. No.: US 2026/0210431 A1
(43) Pub. Date: Jul. 23, 2026

(54) Drive Unit and Vehicle

(71) Applicant: Daimler Truck AG, Leinfelden-Echterdingen (DE)

(72) Inventors: Guenter KAYRAN, Ostfildern (DE); Frank STEFFENS, Ostfildern (DE)

(21) Appl. No.: 19/141,634

(22) PCT Filed: Dec. 13, 2023
(86) PCT No.: PCT/EP2023/085636

§ 371 Date: Jun. 20, 2025

(30) Foreign Application Priority Data
Dec. 22, 2022 (DE) 10 2022 134 481.9

(51) Int. Cl. F16H 37/04; B60K 1/02; B60K 17/08; B60K 17/28; F16H 37/08

(52) U.S. Cl. CPC F16H 37/04; B60K 1/02; B60K 17/08; B60K 17/28; F16H 37/0806

(57) ABSTRACT

A drive unit for a vehicle includes a reduction group and a main transmission. At least two electric motors are mounted on the reduction group which each act on a separate torque path which is in engagement with a respective one of two main shafts in the main transmission. At least two idler gears run on each of the two main shafts and are configured to engage with one of at least two fixed gears running on a countershaft of the main transmission. Each of the fixed gears is configured to engage with one of the idler gears of each of the two main shafts with a same transmission ratio.

### BACKGROUND AND SUMMARY OF THE INVENTION

The invention relates to a drive unit for a vehicle and a vehicle.

DE 10 2013 218 454 A1 describes a transmission, in particular a dual-clutch transmission, for a motor vehicle, comprising at least two partial transmissions, wherein each of the partial transmissions comprises at least one input shaft, and wherein an output shaft is arranged as the output shaft of both partial transmissions, wherein the at least one input shaft is arranged on an input shaft axis and the output shaft is arranged on the input shaft axis or on a countershaft axis, in particular parallel to the input shaft axis, and wherein a reduction gear having at least one countershaft is arranged, wherein the at least one countershaft is arranged on the countershaft axis, and wherein multiple shifting devices are arranged and wherein at least one of the input shafts can be connected to the output shaft by means of at least two wheel planes and/or at least one shifting element of one of the shifting devices, wherein two solid shafts on the input shaft axis can be coupled directly via a shifting element, and wherein, on the countershaft axis, either a) a shifting device, comprising a single shifting element, is arranged, or wherein b) a shifting device, comprising two shifting elements, is arranged, which is connected to a countershaft designed as a hollow shaft, wherein the countershaft cooperates with at least two wheel planes, which has transmission elements on the same shaft on the input shaft axis, or that c) two or more shifting devices are arranged.

The object of the invention is to specify a novel drive unit for a vehicle as well as a novel vehicle.

A drive unit for a vehicle in accordance with the invention has a reduction group and a main transmission, wherein at least two electric motors are mounted on the reduction group, which each act on a separate torque path which is engaged with a respective one of two main shafts in the main transmission, wherein at least two idler gears run on each of the main shafts and are configured to engage with one of at least two fixed gears running on a countershaft of the main transmission, wherein each of the fixed gears is configured to engage with a respective one of the idler gears of each of the main shafts. According to the invention, each of the fixed gears is configured to engage with one of the idler gears of each of the main shafts with the same transmission ratio. By way of example, the even-numbered gears of the main transmission can be implemented on one of the main shafts and the odd-numbered gears on the other. The solution according to the invention enables the multiple use of identical gearwheel variants, wherein identically designed main shafts can be used.

In one embodiment, the transmission ratio of one of the idler gears of each of the main shafts to the respective associated fixed gear is the reciprocal of the transmission ratio of the other of the idler gears of the same main shaft to the respective associated fixed gear. In this way, the number of gearwheel variants used can be further reduced.

In one embodiment, the ratio of a gear step lies between the two torque paths of the reduction group. Thus, the overall transmission ratio from one of the electric motors to the countershaft differs from the overall transmission ratio from the other electric motor to the countershaft, such that despite the same transmission ratios of idler gears of both main shafts assigned to the same fixed gear, different overall transmission ratios are implemented by shifting these idler gears, for example for a first and a second gear, or for a third and a fourth gear.

In one embodiment, both torque paths each have an identically designed drive pinion for this purpose, wherein the electric motors engage with the respective drive pinion with output pinions of different sizes. This results in only five gearwheel variants.

In one embodiment, the countershaft is connected to a downstream group that has at least two shift positions with different transmission ratios. In this way, the number of shiftable gears is doubled. This can be used to differentiate the type of use, for example off-road and on-road.

In one embodiment, the downstream group has a planetary transmission having a sun gear, a ring gear and a planetary gear set, wherein the sun gear is locked to the ring gear in one of the shift positions such that the planetary gear set rotates with a transmission ratio of one. This shift position can be used in particular for on-road use. The drive unit is very efficient in terms of power transmission due to the fact that no gearwheels rotate in the downstream group.

In one embodiment, at least one power take-off can be arranged on the drive unit, in particular on an output gear of at least one of the electric motors and/or on a drive gear of at least one of the torque paths of the reduction group and/or on one of the idler gears of the main transmission.

In one embodiment, a retarder can be connected to the drive unit, in particular to a cardan shaft at an output of the drive unit.

According to one aspect of the present invention, a vehicle is proposed comprising at least one driven axle and a drive unit as described above, wherein the drive unit is connected to the axle via a cardan shaft at an output of the drive unit.

In one embodiment, the vehicle can be designed as a commercial vehicle.

By adapting the reduction group, electric motors with different characteristics and sizes can be applied without having to recreate the entire drive unit.

The solution according to the invention allows multiple use of gearwheel types. In particular, both main shafts can be designed identically.

The drive unit according to the invention covers two application cases differentiated by the downstream group, for example off-road, characterized by driving characteristics, and on-road, characterized by efficiency.

The drive unit according to the invention is suitable, for example, for construction site vehicles of different sizes (high variance, for example 20 tons to 120 tons). The drive unit can be sequentially powershifted in the respective application.

Exemplary embodiments of the invention are explained in more detail below with reference to the drawings.

### BRIEF DESCRIPTION OF THE DRAWINGS

FIG. 1 is a schematic view of an embodiment of a drive unit for a vehicle;

FIG. 2 is a schematic view of a further embodiment of a drive unit for a vehicle; and

FIG. 3 is a schematic view of a vehicle.

### DETAILED DESCRIPTION OF THE DRAWINGS

Parts corresponding to one another are provided with the same reference numerals in all figures.

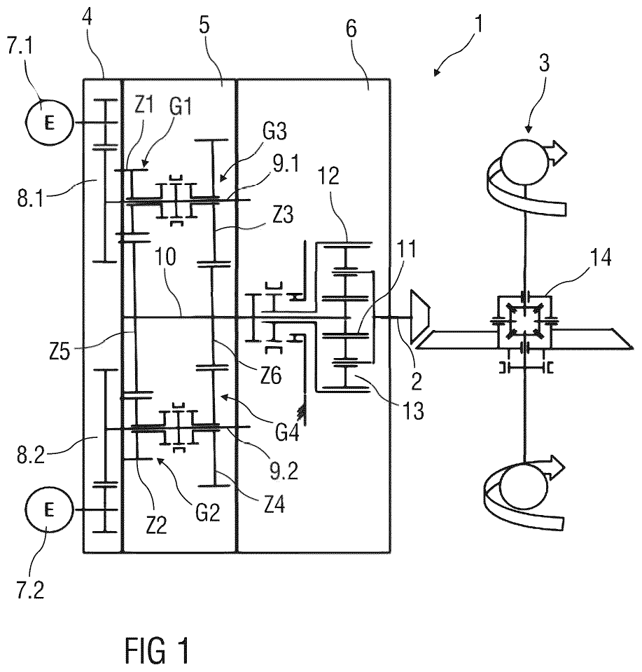

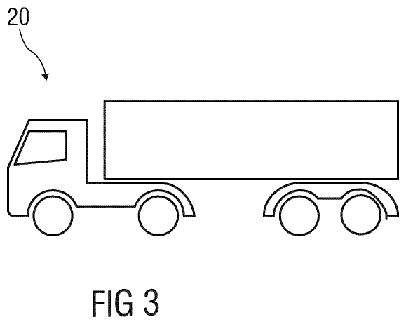

FIG. 1 is a schematic view of an embodiment of a drive unit 1 for a vehicle 20 (depicted in FIG. 3), which is particularly suitable for heavy commercial vehicles that can travel both off-road and on-road. The drive unit 1 is mounted via a cardan shaft 2 on an axle 3, for example the rear axle, of the vehicle 20 with the appropriate transmission ratio. In this combination, the drive unit 1 can drive vehicles 20 with a total mass of up to 120 tonnes, for example.

The axle 3 can have a differential 14, for example.

The drive unit 1 is geometrically stepped, for example, and has three subassemblies, namely a reduction group 4, a main transmission 5 and a downstream group 6. At least two electric motors 7.1, 7.2 are mounted on the reduction group 4. The outputs from these electric motors 7.1, 7.2 are fed through the reduction group 4 into two separate torque paths 8.1, 8.2 and transformed into a desired rotational frequency/torque ratio. The two separate torque paths 8.1, 8.2 then lead into the main transmission 5. The main transmission 5 has two main shafts 9.1, 9.2 and a countershaft 10.

The main shafts 9.1, 9.2 differ in that all even or even-number gears G2, G4 are located on one of the main shafts 9.2 and all odd or odd-numbered gears G1, G3 are located on the other main shaft 9.1. In the main transmission 5, pairs of one of the even gears G2 and G4 and one of the odd gears G1 and G3 have the same transmission ratio and mesh with the same fixed gear Z5, Z6 on the countershaft 10. This arrangement allows the main transmission 5 to be shifted completely sequentially and without load interruption. Both main shafts 9.1, 9.2 can be designed completely identically such that identical parts can be used. The countershaft 10 then transmits the joint torque to the downstream group 6. The downstream group 6 has two shift positions: Low (short transmission ratio) and High (long transmission ratio). The Low shift position is provided for off-road operation and for operation with high tonnages for starting. The High shift position is mainly provided for on-road use. The downstream group 6 has a planetary transmission having a sun gear 11, a ring gear 12 and a planetary gear set 13. In the High shift position, the sun gear 11 is locked to the ring gear 12 and the planetary gear set 13 rotates with a transmission ratio of one.

In particular, two identically designed electric motors 7.1, 7.2 can be provided. Furthermore, the electric motors 7.1, 7.2 can be designed to drive the reduction group 4 directly or with a gear reduction to drive it. It is also conceivable that one of the electric motors 7.1 is designed for direct drive and the other is designed with a with a gear reduction for driving it. The characteristics of the electric motors 7.1, 7.2 can be designed such that their peak power corresponds to around 70% of their continuous power. The reduction group 4 transforms torques and rotational frequencies to an input of the main transmission 5. The special feature here is that the ratio of a gear step lies between the two torque paths 8.1, 8.2 of the reduction group 4. This means that with identical drive pinions of the torque paths 8.1, 8.2, the output pinions of the electric motors 7.1, 7.2 are of different sizes (three different gearwheels in total). This has the effect that in the main transmission 5, the transmission ratio of the first and second gears G1, G2 on the one hand and the transmission ratio of the third and fourth gears G3, G4 on the other hand are identical, wherein the transmission ratio of the third and fourth gears G3, G4 can be the reciprocal of the transmission ratio of the first and second gears G1, G2. The four gears G1, G2, G3, G4 each have a pairing of two gearwheels, one of which runs as an idler gear Z1 to Z4 on the respective main shaft 9.1, 9.2 and another as a fixed gear Z5, Z6 on the countershaft 10. This theoretically results in eight gearwheels, the number of which can, however, be reduced to six by using, on the countershaft 10, on the one hand, one and the same gearwheel designed as a fixed gear Z5 with a gearwheel designed as an idler gear Z1 for the first gear G1 and a gearwheel designed as an idler gear Z2 for the second gear G2 and, on the other hand, one and the same gearwheel designed as a fixed gear Z6 with a gearwheel designed as an idler gear Z3 for the third gear G3 and a gearwheel designed as an idler gear Z4 for the fourth gear G4. The same transmission ratio of the first and second gears G1, G2 on the one hand and the third and fourth gears G3, G4 on the other hand enables double gear meshing in the fixed gear Z5, Z6 with identical centre distance. In this way, two gearwheels are saved. The remaining six gearwheels are represented by only two gearwheel variants.

This means that three gearwheel variants for the reduction group 4 and two gearwheel variants for the main transmission 5 result in a total of five gearwheel variants. The countershaft 10 leads to the shiftable planetary gear set 13. This is used to cover the required range of driving characteristics for a vehicle 20 that is to be driven in off-road and on-road operation.

The Low shift position (short transmission ratio) covers off-road use, in particular for starting on loose ground, with high slope angles and/or high gradients. The High shift position (long transmission ratio=1) is used in particular for on-road use. The drive unit 1 is very efficient in terms of power transmission because there are no more gearwheels rolling.

With the drive unit 1 according to the invention, eight gears can be realized with five gearwheel variants and a planetary transmission, four of which are off-road gears and four of which are on-road gears.

In an exemplary embodiment, gearwheels with the following numbers of teeth n are used, which lead to the corresponding transmission ratios i:
output gear of the electric motor 7.1: n=27
drive gear of the torque path 8.1: n=102
transmission ratio of the torque path 8.1: i=3.788
output gear of the electric motor 7.2: n=27
drive gear of the torque path 8.2: n=53
transmission ratio of the torque path 8.2: i=1.988
idler gear Z1, Z2: n=26
fixed gear Z5: n=49
transmission ratio of the gears G1 and G2: i=1.884
idler gear Z3, Z4: n=49
fixed gear Z5: n=26
transmission ratio of the gears G3 and G4: i=0.510
ring gear 12: n=90
sun gear: 11: n=25
planetary gear set: n=31
transmission ratio in Low shift position: i=4.6
transmission ration in High shift position: i=1

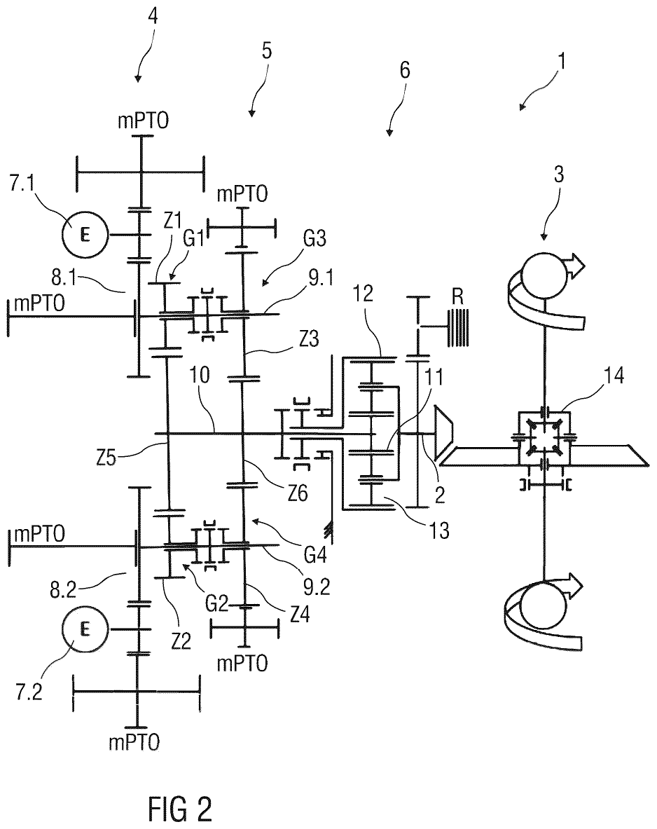

FIG. 2 is a schematic view of the drive unit 1 with exemplary power take-offs mPTO.

The drive unit 1 can be provided with one or more power take-offs mPTO (in particular motor, transmission, side, axial PTO), which can be in engagement with:
an output gear of at least one of the electric motors 7.1, 7.2,
a drive gear of at least one of the torque paths 8.1, 8.2 of the reduction group 4, and/or
one of the idler gears Z1 to Z4 of the main transmission 5.

Furthermore, a retarder R can be provided, which can be in engagement with the cardan shaft 2, for example.

FIG. 3 is a schematic view of a vehicle 20, for example a commercial vehicle, in particular a heavy commercial vehicle, which can have the driven axle 3 and the drive unit 1 described above, wherein the drive unit 1 is connected to the axle 3 via the cardan shaft 2.

### LIST OF REFERENCE CHARACTERS

1 drive unit
2 cardan shaft
3 axle
4 reduction group
5 main transmission
6 downstream group
7.1 electric motor
7.2 electric motor
8.1 torque path
8.2 torque path
9.1 main shaft
9.2 main shaft
10 countershaft
11 sun gear
12 ring gear
13 planetary gear set
14 differential
20 vehicle
G1 gear
G2 gear
G3 gear
G4 gear
mPTO power take-off
R retarder
Z1 bis Z4 idler gear
Z5, Z6 fixed gear

1.-10. (canceled)

11. A drive unit (1) for a vehicle (20), comprising:
a reduction group (4); and
a main transmission (5);
wherein at least two electric motors (7.1, 7.2) are mounted on the reduction group (4) which each act on a separate torque path (8.1, 8.2) which is in engagement with a respective one of two main shafts (9.1, 9.2) in the main transmission (5);
wherein at least two idler gears (Z1 to Z4) run on each of the two main shafts (9.1, 9.2) and are configured to engage with one of at least two fixed gears (Z5, Z6) running on a countershaft (10) of the main transmission (5);
wherein each of the fixed gears (Z5, Z6) is configured to engage with one of the idler gears (Z1 to Z4) of each of the two main shafts (9.1, 9.2) with a same transmission ratio.

12. The drive unit (1) according to claim 11, wherein the transmission ratio of one of the idler gears (Z1 to Z4) of each of the two main shafts (9.1, 9.2) to the respectively assigned fixed gear (Z5, Z6) is a reciprocal of the transmission ratio of the other of the idler gears (Z1 to Z4) of the same main shaft (9.1, 9.2) to the respectively assigned fixed gear (Z5, Z6).

13. The drive unit (1) according to claim 11, wherein a ratio of a gear step lies between the torque paths (8.1, 8.2).

14. The drive unit (1) according to claim 13, wherein both torque paths (8.1, 8.2) each have an identically formed drive pinion and wherein the at least two electric motors (7.1, 7.2) engage with the respective drive pinion with output pinions of different sizes.

15. The drive unit (1) according to claim 11, wherein the countershaft (10) is connected to a downstream group (6) that has at least two shift positions with different transmission ratios.

16. The drive unit (1) according to claim 15, wherein the downstream group (6) has a planetary transmission having a sun gear (11), a ring gear (12), and a planetary gear set (13) and wherein the sun gear (11) is locked to the ring gear (12) in one of the at least two shift positions such that the planetary gear set (13) rotates with a transmission ratio of one.

17. The drive unit (1) according to claim 11, wherein at least one power take-off (mPTO) is disposed on an output gear of at least one of the at least two electric motors (7.1, 7.2) or on a drive gear of at least one of the torque paths (8.1, 8.2) or on one of the at least two idler gears (Z1 to Z4).

18. The drive unit (1) according to claim 11, wherein a retarder (R) is connected to a cardan shaft (2) at an output of the drive unit (1).

19. A vehicle (20), comprising:
a driven axle (3); and
the drive unit (1) according to claim 11;
wherein the drive unit (1) is connected to the driven axle (3) via a cardan shaft (2) at an output of the drive unit (1).

20. The vehicle (20) according to claim 19, wherein the vehicle is a commercial vehicle.
